(19) United States
(12) Patent Application Publication
(10) Pub. No.: US 2012/0112924 A1
(43) Pub. Date: May 10, 2012

(54) Systems and Methods for Providing a Wireless Power Provision and/or an Actuation of a Downhole Component

(76) Inventors: Bruce A. Mackay, Sugar Land, TX (US); Julius Kusuma, Somerville, MA (US)

(21) Appl. No.: 13/229,466

(22) Filed: Sep. 9, 2011

Related U.S. Application Data
(60) Provisional application No. 61/411,528, filed on Nov. 9, 2010.

(51) Int. Cl. G01V 3/00

(52) U.S. Cl. 340/854.6

(57) ABSTRACT

Systems and methods provide wireless power and actuation of a downhole component within a borehole formed in a formation. The systems and method have a first downhole component positioned within the borehole and connected to and/or in communication with a power source. A wireless transmitter is electrically connected to the first component and is adapted to wirelessly transmit electrical power. A second downhole component is in communication with the wireless transmitter to receive the electrical power from the wireless transmitter. The second component is actuated upon receiving the electrical power to perform a task related to the borehole or formation about the borehole.

### CROSS-REFERENCE TO RELATED APPLICATIONS

This application claims priority to U.S. Provisional Application 61/411,528 filed Nov. 9, 2010, the entirety of which is incorporated by reference.

### BACKGROUND OF THE DISCLOSURE

A wellbore or borehole (hereinafter “borehole”) is generally drilled into the ground to recover natural deposits of hydrocarbons and/or other desirable materials trapped in a subsurface geological formation (hereinafter “formation”) in the Earth's crust. The borehole is drilled to penetrate the formation in the Earth's crust that contains the trapped hydrocarbons and/or other materials. As a result, the trapped hydrocarbons and/or materials are released from the formation and/or recovered via the borehole.

Traditionally, downhole components, such as tools and/or devices are positioned within the borehole to collect one or more measurements and/or perform one or more tasks associated with the borehole, the formation and/or the like. Electrical power must be provided to actuate the downhole components so that the downhole components may collect the measurements and/or perform the tasks. Often, the downhole components include a power source for generating and/or providing electrical power, which is typically a battery or a turbine generator. To utilize said power source, a direct wired electrical connection must be established and maintained between the power source and the downhole components requiring electrical power.

Some downhole components, however, are incapable of receiving, establishing and maintaining direct wired electrical connections with a power source. For example, a downhole component may be positioned downhole of a component incapable of being hard wired, such as a packer. Thus, establishing and maintaining direct wired electrical connections between a non-wired downhole component and a power source and/or an electrically-connected downhole component is often very difficult, if not impossible.

### BRIEF DESCRIPTION OF THE DRAWINGS

FIG. 1 illustrates a block diagram of a system in accordance with disclosed embodiments and which can be used in practicing embodiments of the method of the present disclosure.

FIG. 2 illustrates a block diagram of a system in accordance with disclosed embodiments and which can be used in practicing embodiments of the method of the present invention.

### DETAILED DESCRIPTION

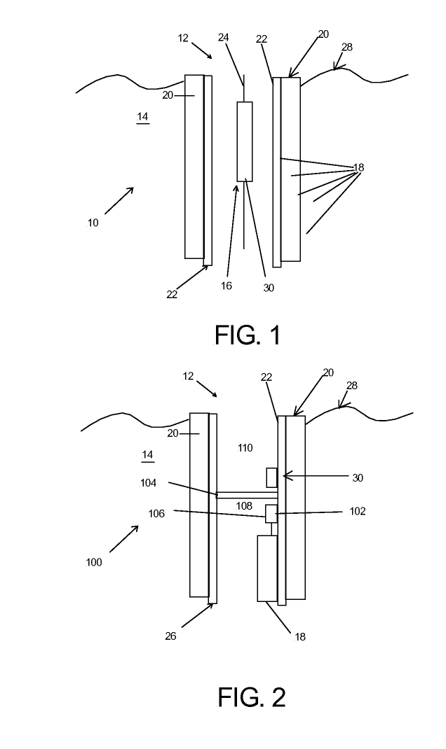

Referring now to the drawings wherein like numerals refer to like parts, FIG. 1 illustrates a wellsite system 10, which may be onshore or offshore, in which the present systems and methods for providing wireless power and/or data transmissions to downhole components may be employed. A borehole 12 is formed in subsurface formations 14 (hereinafter “formation 14”) by rotary drilling. Embodiments of the disclosure may be used with vertical, horizontal and/or directional drilling. The borehole 12 may include a first portion that may be referred to as a first borehole and a second portion that may be referred to as a second borehole. The second borehole may be a secondary borehole to the first borehole. In embodiments, the borehole 12 may include one or more wellbores, such as, for example, a first wellbore and a second wellbore and/or the second wellbore may be a secondary wellbore to the first wellbore. The wellsite system 10 may be used as an example system in which the disclosure may be incorporated, but a person having ordinary skill in the art will understand that the disclosure may be used in any downhole application, such as logging, formation evaluation, drilling, sampling, reservoir testing, completions, flow assurance, production optimization, cementing and/or abandonment of the borehole 12.

The wellsite system 10 may be used for reservoir control and management and may have a first downhole component 16 (hereinafter “first component 16”) that may be positioned, conveyed and/or deployed within a borehole 12 and/or the formation 14 as shown in FIG. 1. The first component 16 may be located and/or positioned adjacent to and/or in proximity to one or more second downhole components 18 (hereinafter “second components 18”). In embodiments, the first component 16 may be directly or indirectly connected to and/or in communication with a power source. In embodiments, the first component 16 may be an electrically powered tool and the power source may be integrated into or integral with the first component 16. The first component 16 may be, for example a conductor which may be connected to an intermediate station located at an intermediate position within the borehole 12 and/or a surface station located at the Earth's surface 28. In embodiments, the first component 16 may be a conductor which may be wirelessly connected to and/or in communication with another wireless link located at the intermediate station or the Earth's surface 28. The first component 16 may be, for example, a measure-while-drilling tool which may contain a power source, such as, for example, a generator or a battery. The first component 16 may also be referred to as a transmitting downhole component. For example, the first component 16 may be configured and/or adapted to transmit wireless power and/or wireless electronic instructions within the borehole 12.

In embodiments, the second components 18 may be devices, such as, for example, be a downhole wellbore tool connected to a drill string (not shown in the figures) or otherwise located within the borehole 12. For example, the second components 18 may be temporarily or permanently installed within the borehole 12 and/or the formation 14. The second components 18 may be referred to as one or more receiving downhole components. The second components 18 may be deployed into the borehole 12 by a type of conveyance different from the type of conveyance for the first component 16.

The second components 18 may be configured and/or adapted to perform, execute and/or complete one or more tasks associated with the wellsite system 10, the borehole 12, the formation 14 and/or a drill string (not shown in the drawings). The second components 18 may have or be programmed with logic for performing the one or more tasks, and may, upon receiving the wireless power from the first component 16, execute the logic to perform the one or more tasks. The wireless electronic instructions may relate to one or more tasks which may be performed by the second components 18 within the borehole 12 and/or the formation 14. The second component 18 may be actuated by the wireless power received from the first component 16 to obtain one or more measurements associated with the borehole 12 or perform the one or more tasks related to the borehole 12 or formation 14 about the borehole 12.

In embodiments, the wellsite system 10 may include cement 20, piping 22 (see FIG. 1) and/or casing 26 (see FIG. 2) which may be located within the borehole 12, the first borehole, the second borehole, the first wellbore and/or the second wellbore. The cement 20 may be located between the borehole 12 and the piping 22 (see FIG. 1) and/or the casing 26 (see FIG. 2). The second components 18 may be located within and/or connected to the borehole 12, the cement 20, the piping 22 (see FIG. 1) and/or the casing 26 (see FIG. 2). In embodiments, the first component 16 may be located within the first borehole or wellbore and the second components may be located within the first borehole, the first wellbore, the second borehole and/or the second wellbore. It should be understood that the wellsite system 10 may include any number of cements, casings, pipings, first components and/or second components as known to one of ordinary skill in the art.

The one or more second components 18 may be a tool, a sensor, or another downhole component associated with the wellsite 10. For example, the second components 18 may be tools, sensors, or other devices for measuring a characteristic of the wellsite 10, the drill string, the borehole 12 and/or the formation 14. In embodiments, the second components 18 may be one of the following types of devices that measure formation characteristics: a resistivity measuring device; a directional resistivity measuring device; a sonic measuring device; a nuclear measuring device; a nuclear magnetic resonance measuring device; a pressure measuring device; a seismic measuring device; an imaging device; a formation sampling device; a natural gamma ray device; a density and photoelectric index device; a neutron porosity device; and a borehole caliper device. In embodiments, the one or more second components 18 may be one or more devices for measuring characteristics of the drill string and/or may include one or more of the following types of measuring devices: a weight-on-bit measuring device; a torque measuring device; a vibration measuring device; a shock measuring device; a stick slip measuring device; a direction measuring device; an inclination measuring device; a natural gamma ray device; a directional survey device; a tool face device; a borehole pressure device; and a temperature device.

The second components 18 may be a wireline configurable tool which may be a tool commonly conveyed by wireline cable. For example, the wireline configurable tool may be a logging tool for sampling or measuring characteristics of the formation 14, such as gamma radiation measurements, nuclear measurements, density measurements, and porosity measurements.

In an embodiment, the second components 18 may be or may include one or more sensors. The one or more sensors of the second components 18 may detect, collect, log and/or store data concerning the operation of the wellsite 10, the borehole 12, the formation 14 and/or the drill string. For example, the one or more sensors of the second components 18 may detect, collect, log and/or store any data that may be detected, collected, logged and/or stored as known to one of ordinary skill in the art.

The wellsite system 10 may include a telemetry system (not shown in the drawings) to provide an interface for electronic communications between the Earth's surface 28 and the first components 16. The telemetry system may comprise one or more of the following telemetry systems: mud pulse telemetry, acoustic telemetry, electromagnetic telemetry, wireline telemetry or any other telemetry system. The present disclosure should not be deemed limited to a specific embodiment of the telemetry system that may be utilized by the wellsite system 10.

The second components 18 may be configured and/or adapted to receive the wireless power and/or wireless electrical instructions (hereinafter “wireless electrical power and/or instructions”) from the first component 16. Upon receiving the wireless electrical power from the first component 16, the second components 18 may be actuated and/or the logic may be executed to perform the one or more tasks. As a result, the first component 16 may control when and/or where one or more tasks may be performed, executed and/or completed by the second components 18. The first component 16 may wirelessly provide necessary wireless power to the second components 18 for performing, executing and/or completing the one or more tasks. The one or more tasks performed by the second components may be selected from a group including heating a portion of the first borehole or a portion of a second borehole, restricting or halting fluid flow within the first borehole or within a second borehole, moving a shunt, a expandable screen or a slidable screen from a first position to a second position within the first borehole, expanding or contracting a packer within the borehole, releasing an inhibitor or a solvent into the first borehole, mechanically agitating fluid within the first borehole and/or any combination thereof The one or more tasks that may be performed by the second components 18 may be any downhole task.

The first component 16 may position, convey and/or deploy into the borehole 12 via an arrangement for conveyance 24. For example, the arrangement for conveyance 24 may be a slickline, a wireline, a drill stem, a coiled tubing, a drill string or a tractor. As shown in FIG. 1, the arrangement for conveyance 24 may be referred to as a wireline 24 and may position the first component 16 within the borehole 12. The arrangement for conveyance 24 may be any conveyance capable of positioning, conveying and/or deploying the first component 16 within the borehole 12 as known to one of ordinary skill in the art.

In embodiments, the first component 16 and the second components 18 may be provided with one or more local power sources (not shown in the drawings), such as, for example, one or more batteries to provide and/or store electrical power. When the first component 16 is provided with the local power sources, the first component 16 may be deployed into the borehole 12 via slickline (not shown in the drawings). Alternatively, the first component 16 may be connected to a power source (not shown in the figures) which may be located at the Earth's surface 28 via the wireline 24 (see FIG. 1). In embodiments, the first component 16 is itself a power source. The first component 16 may transmit the wireless power and/or instructions to the second components 18 to stimulate and/or actuate one or more second components 18. Upon receiving the wireless power and/or instructions from the first component 16, the second components 18 may perform, execute and/or complete the one or more tasks as instructed by the first component 16 via the wireless instructions. The wireless power received from the first component 16 may be stored in one or more local power sources of the second components 18 when the second components 18 are provided with one or more local power sources.

In embodiments, the second components 18 may not be in direct electrical communication with one or more local power sources and/or with one another as shown in FIG. 1. The first component 16 may be deployed into the borehole 12 on the wireline 24 such that electrical power may be provided to the first component 16 via the wireline 24. The first component 16 may comprise a wireless power transmitter 30 (hereinafter “transmitter 30”). The transmitter 30 of the first component 16 may be configured and/or adapted to wirelessly transmit wireless power and/or instructions wirelessly to the second components 18, which are not in direct electrical communication with the first component 16. The second components 18 may include a wireless power receiver and/or may be electrically connected to a wireless power receiver 102 (hereinafter “receiver 102”) as shown in FIG. 2 which may be configured and/or adapted to receive wireless power and/or instructions from transmitter 30 of the first component 16.

As shown in FIG. 1, the first component 16 may be positioned within the borehole 12 at a transmitting position, via the wireline 24, which may be adjacent to one or more second components 18. After the first component 16 is positioned at the transmitting position, the transmitter 30 of the first component 16 may be in electrical communication with the receiver 102 and/or the one or more second components 18. The transmitter 30 of the first component 16 may transmit the wireless power and instructions within the borehole 12 to the receiver 102 and/or the one or more second components 18. The wireless electrical power and/or instructions may be received by the receiver 102 of the one or more second components 18. As a result, the one or more second components 18 may utilize the wireless power received by the receiver 102 to execute the logic and/or to perform, execute and/or complete the one or more tasks.

FIG. 2 illustrates a wellsite system 100 which may be configured and/or adapted to wirelessly transmit wireless power and/or instructions across multi-lateral components and/or across one or more completion zones. The wellsite 100 may include the cement 14, the casing 26 and/or the piping 22 which may be located within the borehole 12 in the formation 14. The wellsite system 100 may include at least one second component 18, the transmitter 30, the receiver 102 and/or at least one packer 104. The at least one packer 104 may extend laterally across the borehole 12 in such a way that the borehole 12 may be divided and/or separated into a bottom borehole zone 108 (hereinafter “bottom zone 108”) and a top borehole zone 110 (hereinafter “top zone 110”). In embodiments, the bottom zone 108 may be referred to as a bottom borehole or wellbore, and the top zone 110 may be referred to as a top borehole or wellbore. The receiver 102 may be electrically connected and/or in communication with one or more second components 18 via, for example, a wired connection 106. It should be understood that the present specification is not to be deemed limited to a specific embodiment of the packer 104 and/or a specific number of borehole zones and/or second components 18.

The transmitter 30 may be powered by a separate power source (not shown in the figures) or by a battery (not shown in the figures) connected to the transmitter 30. The transmitter 30 may transmit wireless power and/or instructions from the top zone 110 of the borehole 12 across the packer 104 to the receiver 102 in the bottom zone 108 of the borehole 12. The wireless power and/or instructions received by the receiver 102 may be transmitted to the at least one second component 18 via the wired connection 106. As a result, the at least one second components 18 may utilize the wireless power and/or instructions received from the transmitter 30 to execute the logic and/or to perform and/or complete the one or more tasks.

One or more second components 18 of the wellsite system 10 and/or the wellsite system 100 (hereinafter “wellsite systems 10, 100”) may be electrically connected to one or more rechargeable batteries (not shown in the figures) for storing electrical power. The receiver 102 of the one or more second components 18 may receive the wireless power from the transmitter 30 and may store the received wireless power in the one or more rechargeable batteries. The one or more rechargeable batteries of the one or more second components 18 may be empty, full or partially full prior to receiving the wireless power received from the transmitter 30. As a result the one or more rechargeable batteries of the one or more second components 18 may be recharged by the wireless power received from the first components 16. In embodiments, the one or more second components 18 may be an electric submersible pump (hereinafter “ESP”), a flow-meter, and/or a downhole component within the borehole 12 and/or completions which may be difficult to service. It should be understood that the number rechargeable batteries connected to the one or more second components 18 of the wellsite systems 10, 100 may be any number of rechargeable batteries.

In embodiments, wireless power and/or instructions in the form of at least one wireless transmission from the transmitter 30 may be transmitted to the receiver 102 and/or the second components 18 over at least one wireless connection. In embodiments, the instructions may be included or embedded within the at least one wireless power transmission between the transmitter 30 and receiver 102 and/or one or more second components 18 over the wireless connection. As a result, the wireless instructions may be transmitted or communicated from the transmitter 30 and/or the first component 16 to the receiver 102 and/or one or more second components 18 via the at least one wireless transmission. It should be understood that an amount of wireless power and/or instructions, a number of wireless transmissions and/or a duration of time for the wireless transmissions capable of being produced and/or transmitted by the transmitter 30 and/or the first component 16 may be any amount of wireless power and/or instructions, any number of wireless transmissions and/or any duration of time.

The at least one wireless transmission may be carried out by the transmitter 30 and receiver 102 by induction, resonant inductive coupling, inductive power transfer, electrodynamic inductive effect, radio wave frequencies, microwave frequencies or transmissions, laser beams and/or evanescent wave coupling. In embodiments, the at least one wireless transmission may require the transmitter 30 and the receiver 102 to be configured and/or arranged in such a way that the transmitter 30 and the receiver 102 are in a line of sight with each other, directly adjacent to each other, and/or in a close proximity to each other.

In embodiments, the at least one wireless transmission may be based on a strong coupling between electromagnetic resonant objects, such as, the transmitter 30 and the receiver 102 to wirelessly transfer the wireless power and/or instructions. The transmitter 30 and the receiver 102 may contain one or more magnetic loop antennas critically tuned to the same or substantially the same frequency. As a result of the magnetic loop antennas being tuned to the same or substantially the same frequency, strong-coupled resonances may be achieved between the transmitter 30 and the receiver 102 to achieve high power-transmission efficiency between the transmitter 30 and the receiver 102. Moreover, transmission of instructions may be embedded into and/or included with the high power transmission between the transmitter 30 and receiver 102. In embodiments, the wireless power and instructions transfer technology may be, for example, WiTricity or a wireless resonant energy link.

To improve wireless power and instructions transmission between the transmitter 30 and the receiver 102, the transmitter 30 and/or the receiver 102 may require frequency tuning For example, a frequency associated with the transmitter 30 may be tuned to and maintained at the same resonant frequency or substantially the same resonant frequency as the frequency associated with the receiver 102. External effects, such as, for example, temperature, pressure, shock, vibration, borehole conditions, and other effects may change the resonant frequency of the receiver 102. The resonant frequency may be controlled to maintain the high power-transmission efficiency associated with the one or more wireless transmissions. The present disclosure should not be limited to a specific embodiment of the external effects that may change the resonant frequency of the transmitter 30 and the receiver 102.

A control loop may be needed to control and/or maintain the resonant frequency of the transmitter 30 and the receiver 102. Because more than one of the external effects may destabilize tuning or change the resonant frequency of the receiver 102, a simple feedback loop may not effectively control and/or maintain the resonant frequency of the transmitter 30 and the receiver 102. Thus, a complex frequency control loop may be utilized to control and/or maintain the resonant frequency of the transmitter 30 and the receiver 102. The complex frequency control loop may utilize several sources of external information, including, but not limited to, information associated with external effects, such as, frequency, power efficiency, temperature, pressure, vibration, borehole conditions and the like. It should be understood that the external information may be any information associated with any type of external effect that may change the resonant frequency of the transmitter 30 and the receiver 102.

In embodiments, the first component 16, the one or more second components 16, the transmitter 30 and/or receiver 102 may collect and/or log control information associated with the external information and/or the wireless power and/or instructions and/or frequency received from the transmitter 30. For example, the receiver 102 may continuously or periodically determine the control information and may execute a complex frequency control loop based on the control information. As a result, the complex frequency control loop may adjust the frequency tuning based on the control information and/or maintain the resonant frequency of the transmitter 30 and the receiver 102 for the high power-transmission efficiency of the wireless transmission.

For example, initially the operational resonant frequency of the receiver 102 may be set or tuned to the same or substantially the same initial resonant frequency of the transmitter 30. One or more of the external effects may cause the operational resonant frequency of the receiver 102 to increase or decrease to a current resonant frequency. The second components 18 may measure the amount of electrical power and frequency received by the receiver 102 and/or the second components 18 from the transmitter 30 via a first wireless transmission. The receiver 102 may transmit the measured amount of electrical power and frequency data and/or information to a measuring module (not shown in the drawings) which may be connected to the transmitter 30 or incorporated into the first component 16. In embodiments, the receiver 102 may be configured and/or adapted to transmit data and/or information to the measuring module via a wireless communication connection or any other communication method.

The measuring module of the transmitter 30 or the first component 16 may receive data and information from the receiver 102 and may determine that a measured amount of wireless power and/or instructions and frequency is less than optimal or not efficient when compared to the amount of wireless power and/or instructions and frequency that was sent to the receiver 102 and/or the one or more second components 18 via the first wireless transmission from the transmitter 30. The first component 16 and/or the transmitter 30 may adjust the frequency for a subsequent second wireless transmission by adjusting the resonant frequency of the transmitter 30 based on the data and/or information received from the receiver 102 and/or the one or more second components 18. As a result, the transmitter 30 may transmit the second wireless transmission to the receiver 102 and/or the one or more second components 18 over the wireless connection at the adjusted resonant frequency of the transmitter 30, which may or may not be the same or substantially same frequency as the resonant frequency of the receiver 102 and/or the one or more second components 18.

The receiver 102 and/or the one or more second components 18 may measure the amount of wireless power and/or instructions and frequency received from the second wireless transmission and/or may transmit the measured data and/or information to the first component 16 which may be executing a subsequent complex control loop. The first component 16 may receive the data and/or information and may determine that the measured amount of wireless power and/or instructions and frequency may be optimal and/or that the adjusted resonant frequency of the transmitter 30 may be the same or substantially the same frequency as the current resonant frequency of the receiver 102. As a result, the frequency of subsequent wireless transmissions may be unchanged from the frequency of the second wireless transmission. Alternatively, the first component 16 may receive the data and/or information and may determine that the measured amount of wireless power and/or instructions and frequency is not yet optimal and/or that the adjusted resonant frequency of the transmitter 30 may not be the same frequency as the current resonant frequency of the receiver 102. As a result, the adjusted frequencies of subsequent wireless transmissions may be increased or decreased by the transmitter 30 and/or the first component 16 until a subsequent measured amount of received wireless power and/or instructions and frequency may be optimized and/or the adjusted resonant frequency of the transmitter 30 may be the same or substantially the same frequency as the current resonant frequency of the receiver 102. Thus, the transmitter 30 and/or the receivers 102 may be continuously or periodically tuned to the same or substantially the same resonant frequency.

A wireless power connection may be established, formed and/or maintained between, for example, the first component 16 and the one or more second components 18 as shown in FIG. 1. Further, a wireless power connection may be established, formed and/or maintained between, for example, the transmitter 30 and the receiver 102 as shown in FIG. 2. The wireless connection may electrically connect the first component 16 to the one or more second component 18 and/or the transmitter 30 and/or first component 16 to the receiver 102.

The receiver 102 and/or the one or more second components 18 may receive the at least one wireless transmission and may convert the at least one wireless transmission to electrical power. The second components 18 may be actuated and/or operated with and/or may be powered by the electrical power received over the at least one wireless transmission. As a result, the one or more second components 18 may perform and/or complete the one or more tasks as instructed by wireless instructions received from the first component 16.

The first component 16 may produce and/or provide data and/or information received the one or more second components 18 in the form of at least one communication signal. The first component 16 may transmit the at least one communication signal of data and/or information to the telemetry system and/or the wireline 24. As a result, data and/or information detected, collected, logged and/or stored by the first component 16 may be communicated to the Earth's surface 28 via the telemetry system and/or the wireline 24.

In embodiments, communication signals may be received by the first component 16 from a control unit or processor (not shown in the drawings) at the Earth's surface 28 via bidirectional communication provided by the telemetry system and/or the wireline 24. The communication signals received from the control unit may control processes, functions and/or operations of the first component 16, the one or more second components 18, the transmitter 30, the receiver 102 and/or the packer 104. The communication signals may be transmitted downhole to the first component 16 via the telemetry system, an additional wireless connection and/or the wireline 24. The communication signals received by the first component 16 may include one or more instructions that may be transmitted to the one or more second components 18 and/or the receiver 102 via the wireless instructions sent from the transmitter 30. The wireless power and/or instructions may be received by the one or more second components 18 and/or the receiver 102, and the one or more second components 18 may be actuated by the wireless power and/or instructions. As a result, the one or more second components 18 may perform, execute and/or complete one or more tasks which may be based on the wireless instructions transmitted from the transmitter 30.

In embodiments, the first component 16 and the one or more second components 18 (hereinafter “first and second components 16, 18”) may be selected to perform, execute and/or complete one or more tasks related to controlling and/or managing fluid flow within the borehole 12. As a result, the one or more tasks executed by the first and second components 16, 18 may control and/or manage fluid flow within the borehole 12 throughout the lifetime of the well produced by the borehole 12.

In embodiments, the one or more tasks performed, executed and/or completed by the first and second components 16, 18 may relate to and/or may affect flow assurance within the borehole 12 via resistive heating and/or agitation. For example, during a recovery of heavy crude oil by Steam Assisted Gravity Drainage (hereinafter “SAG-D”), the crude oils may begin to thicken after the crude oil leaves a heated zone of the borehole 12. The thickening of the crude oil after the crude oil leaves the heated zone may depend on one or more factors, such as, for example, a treatment temperature within a SAG-D zone, a composition of the crude oil and/or the like. Thickening of the crude oil may increase a cost of recovery of the crude oil and may, in some cases, require wellbore intervention in order to recover the crude oil. The present specification should not be deemed as limited to a specific embodiment of the one or more factors affecting the thickening of the crude oil.

To prevent thickening of the crude oil outside the heated zone, the one or more second components 18 may be, for example, one or more resistive heating element which may be positioned within the borehole 12. The first component 16 may transmit wireless power and/or instructions to the one or more second components 18 via the at least one wireless transmission. As a result, the first component 16 may actuate and/or power the one or more second components 18 via the wireless power and/or instructions. The one or more second components 18 may be activated and may produce and/or give off heat to warm a portion of the borehole 12 located adjacent to the one or more second components 18. As a result, portions of borehole 12 may be selectively heated and/or warmed via the heat transmitted from the one or more second components so that the crude oil may not thicken. Moreover, the one or more second components 18 may be coupled with a separate ESP which may be actuated and operated via wireless power and/or instructions transmitted from the first component 16.

In embodiments, the borehole 12 may be a main wellbore of a multilateral well (not shown in the drawings) which may also include one or more lateral sections connecting to the borehole 12. The borehole 12 and/or the multilateral well may be configured to spatially interface with the formation 14 such that recovery of hydrocarbons from the formation 14 may be surprisingly improved and/or efficient over the lifetime of the multilateral well. The one or more tasks performed, executed and/or completed by the first and second components 16, 18 may monitor and adjust fluid flow from the one or more lateral sections of the multilateral well. The one or more tasks may allow one or more operators at the Earth's surface 28 to dynamically respond to one or more production conditions, such as, for example, a total reservoir pressure, a water cut, a deconsolidation and/or the like. It should be understood that the present specification should not be deemed as limited to a specific embodiment of the one or more production conditions.

The one or more second components 18 may be, for example, one or more valves which may be positioned and/or located within the borehole 12 at a lateral junction or within one or more lateral sections of the multilateral well. As a result, the one or more second components 18 may allow the one or more operators to partially restrict, substantially restrict or even halt fluid flow from one or more of the lateral sections of the multilateral well. The one or more second components 18 may be adapted and/or configured to receive the wireless power and/or instructions from the first component 16 when the first component 16 may be located in proximity to the one or more second components 18. As a result, the one or more second components may be actuated by the wireless power and/or instructions. By activating the one or more second components 18 with the wireless power and/or instructions, the one or more second components 18 may transmit information and/or data to the first component 16. The data and/or information may relate to and/or be associated with the extent of the constriction of the one or more lateral sections of the multilateral well by the one or more second components 18.

The first component 16 may obtain and/or access the information and/or data received from the one or more second components 18 and may adjust the restriction, fluid flow or regulated the downhole choke provide by the one or more second components 18 in real-time. Alternatively, the one or more operators may obtain and/or access the information and/or data from the first component 16 which may allow the one or more operators to adjust the restriction, fluid flow or regulated the downhole choke provide by the one or more second components 18 in real-time. The one or more second components 18 may be integrated with a flow-meter such that the constriction decisions made by the one or more operators may be made based on local flow rates measured by the flow-meter. As a result, the real-time constriction decisions made by the one or more operators may not be based on overall production rates for the multilateral well which may include errors, such as, errors based on a multiphase flow. Moreover, the first component 16 may be integrated with a flow-meter for measuring local flow rates when the first component 16 is located within the borehole 12.

In embodiments, the one or more tasks performed, executed and/or completed by the first and second components 16, 18 may control and/or operate one or more shunts during a gravel pack operation and/or a fraction pack operation. A system for gravel pack operations may have a sand and/or gravel slurry which may be pumped into a space between a prepositioned screen and the formation 14. The formation 14 may be a deconsolidating formation and the sand slurry may be utilized to provide a physically secure high-conductivity pathway from the formation 14 to borehole 12.

The one or more second components 18 may be one or more shunts which may be utilized in conjunction with a bottom hole assembly specialized for completions. The one or more second components 18 may provide and/or ensure even placement of sand and/or gravel outside and/or adjacent to the prepositioned screen. The one or more second components 18 may be configured and/or adapted to respond to and/or be actuated by the wireless power and/or instructions received from the first component 16. As a result, the one or more second components 18 may be actuated and/or operated at a surprisingly greater precision during a gravel pack procedure and/or operation when the first component 16 is integrated into a completions workstring. The one or more shunts of the one or more second components 18 may remain in place to be subsequently actuated by the first component 16 during, for example, a workover, treatments for fines migration, or stimulation treatments which may improve conductivity after a period of production where production decline of the borehole 12 is observed, such as, for example, fraction operations, pack operations, acidizing and/or the like.

In embodiments, the one or more tasks performed, executed and/or completed by the first and second components 16, 18 may power and/or control one or more preplaced expandable and/or sliding screens. The one or more second components 18 may be one or more expandable screens which may be temporarily or permanently positioned and/or located within the borehole 12. The one or more components 18 may be utilized to temporarily or permanently control deconsolidation and/or sand production of the formation 14 during recovery of hydrocarbons from the formation 14. The one or more second components 18 may be pre-installed at one or more locations within the borehole 12 that may be expected to undergo deconsolidation of the formation 14. The first component 16 may be positioned adjacent to one or more of the second components 18 and/or may transmit wireless power and/or instructions to the one or more second components 18. The one or more second components 18 may be actuated by the wireless power and/or instructions such that one or more expandable screens are expanded and/or one or more sliding screens are slide from a first closed position to a second open position within the borehole 12. As a result, deconsolidation and/or sand production of the formation 14 may be controlled by the one or more expandable and/or sliding screens. The one or more second components 18 may be subsequently actuated by the first component 16 so the one or more expandable screens and/or the one or more sliding screens are moved from the second open position to the first closed position.

In embodiments, the one or more tasks performed, executed and/or completed by the first and second components 16, 18 may operate and/or control one or more packers. The one or more second components 18 may be one or more packers which may be adapted and/or configured to correspond to or match one or more borehole, formation and/or reservoir conditions. In embodiments, the one or more second components 18 may be one or more packers having, for example, a single- or a tandem-packer configuration, a single- or a dual-tubing string, and/or a full range of pressure and temperature applications. When provided as one or more packers, the one or more second components 18 may enable efficient fluid flow from the formation 14 and/or injection into the formation 14 to a tubing string and/or a production conduit. The one or more second components 18 may not restrict normal production or injection flow with respect to the formation 14. The one or more second components 18 may be permanent or retrievable, and may be generally set hydraulically, mechanically, and/or by an action of swell-able materials. The one or more second components 18 may be actuated and powered by the wireless power and/or instructions received from the first component 16. As a result, the one or more components 18 within a completion may be activated and/or triggered to expand and/or isolate one or more zones of a completed well.

The one or more operators may isolate one or more zones of a completed well in a deliberate manner by transmitting the wireless power and/or instructions to the one or more second components 18 from the first component 16. As a result, the one or more second components 18 may facilitate improved installation of one or more completions. One or more second components 18 may remain inactivated to allow fluid flow from one or more active zones of the borehole 12 until production conditions may indicate that one or more active zones may be depleted and/or may be sealed off. When the one or more active zones are depleted, the first component 16 may be introduced to the borehole 12 and may actuate the one or more second components 18 in proximity of and/or adjacent to the one or more depleted zones via the wireless power and/or instructions. As a result, the one or more second components 18 may be actuated and/or may selectively “switch off” and/or close the one or more depleted zones to provide for zonal isolation within the borehole 12.

In embodiments, the one or more second components 18 may be one or more packers that may swell in response to the application of electrical power via the wireless power and/or instructions received from the first component 18. For example, the second component 18 may be a hydraulic packer coupled to a pump that may be an integral part of the completion. The pump may receive wireless power from the first component 16 via the at least one wireless transmission. As a result, the pump may be activated and/or may fill the hydraulic packer with, for example, a gas so that the hydraulic packer may be set. In another example, the second component 18 may be a chemical gel packer having one or more chemical components that may be stored in one or more reservoirs within the completion. The one or more chemical components, which may be, for example, one or more water control polymers or one or more reactive chemical resins, may be extruded out from the one or more reservoirs when the second component 18 is activated by the wireless power received from the first component 16. As a result, the extrudent sets the chemical gel packer into one or more depleted zones to provide zonal isolation. The zonal isolation provided by the second component 18 may be especially well suited for highly deviated completions or completions which are non-concentric within the wellbore. Moreover, the zonal isolation provided by the second component 18 may be utilized to protect the formation 14 from damage resulting from fluid loss during completions and workover operations. To prevent damage resulting from fluid loss, the one or more second components 18 may be configured and/or adapted to be one or more isolation valves which may be position a one or more locations within the borehole 12.

In embodiments, the one or more tasks performed, executed and/or completed by the first and second components 16, 18 may release and/or control one or more inhibitors and/or additives into the borehole 12. It is known that wellbore scale buildup may be problematic, and it may be possible, based on analysis of wellbore design and the chemistry of formation waters, to predict where the wellbore scale buildup may occur. One or more inhibitors and/or treatment chemicals may be adapted and/or configured to reduce and/or inhibit wellbore scale buildup in the borehole 12. The one or more second components 18 may be one or more reservoirs that may contain the one or more inhibitors and/or treatment chemicals and may be fitted with release one or more valves and/or one or more pumps. The one or more second components 18 may be activated by the wireless power and/or instructions received from the first component 18. As a result, the one or more second components 18 may release and/or injection the one or more inhibitors and/or treatments chemicals from the one or more reservoirs into the borehole 12 via the one or more valves and/or one or more pumps. In embodiments, the one or more tasks performed, executed and/or completed by the first and second components 16, 18 may control precipitation of one or more asphaltenes, gas hydrates and/or paraffins. One or more asphaltenes, gas hydrates, and paraffins may be components of produced fluid from the formation 14 which may separate and precipitate as the produced fluid ascends the borehole 12 in response to changes in pressure and temperature. As a result, a partial blockage or a complete total blockage may be formed within the borehole 12 by the precipitation of one or more asphaltenes, gas hydrates and/or paraffins. A blockage resulting form gas hydrates may present a safety hazard because gas hydrate plugs may release explosively; therefore, it is generally much safer to prevent formation of any precipitations rather than enter the borehole 12 and remove precipitated material from the borehole 12. All of the potential precipitates of asphaltenes, gas hydrates and paraffins respond to solvent treatments (i.e., precipitates of asphaltenes and paraffins respond to organic solvents such as toluene, limonene, or diesel fuel; and precipitates of gas hydrates respond to methanol and other solvents). Additionally, a number of precipitation inhibitors are available for each potential precipitate of asphaltenes, gas hydrates and paraffins. Local agitation also may prevent or relieve precipitation.

One or more potential “choke points” may be formed and/or caused from the potential precipitates within a borehole 12 which may be predicted from, for example, knowledge of one or more operant pressure, volume and/or temperature conditions and one or more tests on produced fluid from the formation 14. The one or more second components 18 may be one or more permanent or temporally downhole components which may be adapted and/or configured to mechanically agitating the produced fluid from the formation 14. The one or more second components 18 may be positioned and/or located at or near the one or more “choke points” and/or at a site of precipitation. The one or more second components 18 may be actuated and/or powered by the wireless power and/or instructions received from the first component 16. As a result, the one or more second components 18 may mechanically agitate the produced fluid to prevent formation of the one or more “choke points” by the potential precipitates within the borehole 12. In embodiments, the one or more second components 18 may be configured and/or adapted to have a reservoir for dispensation of appropriate and/or treatment chemicals and/or solvents into the produced fluid to prevent formation of the one or more “choke points” by the potential precipitates within the borehole 12. Moreover, the one or more second components 18 may be located in proximity to a precipitate blockage and/or the one or more “choke points”. As a result, the amount of treatment chemicals and/or solvents required to remove the precipitate blockage and/or the one or more “choke points” from the borehole 12 may be substantially lower than the amount of treatment chemicals and/or solvents with a conventional intervention.

In embodiments, the second component 18 may be a sensor located and/or position on or adjacent to a shoe at a bottom of a section of casing. The second component 18 may determine and/or identify when a final portion of a cement slurry may have been pumped through the shoe and/or up the annulus within the borehole 12. The shoe may be configured and/or adapted to have a valve or choke through which the cement slurry may flow when the shoe may be in an open position. The valve or choke of the shoe may be configured and/or adapted to be controlled by the second component 18. The second component 18 may be activated by when a tail of the cement slurry passes through the shoe. As a result, the shoe may contract one or more times in succession. The one or more operators may determine, based on the one or more contractions of the shoe and/or one or more resulting pressure pulses, that the tail of the cement slurry may have passed through the shoe. Pumping the cement slurry into the borehole 12 may be terminated and the shoe may allow backflow of mud out of the annulus until the cement tail is encountered by the shoe and/or located and/or positioned adjacent to the shoe. When the cement tail is encountered by the shoe and/or located adjacent to the shoe, the valve or choke of the shoe may be moved to a closed positioned and/or may be shut and/or may remain shut until the cement within the annulus may have cured or set. As a result, cement may be around the shoe and/or a last stand of pipe. The first component 16 may be introduced into borehole 12 and/or may be positioned and/or located in proximity of the second component 18 and the shoe. The first component 16 may actuate the second component 18 via the wireless power and/or instructions. The second component may be activated by the wireless power and/or instructions and/or may move the valve or choke to the open position so that drilling may subsequently begin or resume.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

What is claimed is:

1. A system for providing wireless power and actuation of a downhole component within a borehole formed in a formation, the system comprising:
a first downhole component positioned within the borehole and in communication with a power source;
a wireless transmitter electrically connected to the first downhole component, the wireless transmitter adapted to wirelessly transmit electrical power; and
a second downhole component in communication with the wireless transmitter to receive the electrical power from the wireless transmitter, wherein the second downhole component is actuated upon receiving the electrical power to perform a task related to one of the borehole and the formation about the borehole.

2. The system according to claim 1, further comprising:
an arrangement for conveyance of the first downhole component configured to position the first downhole component within the borehole, wherein the second downhole component is deployed into the borehole by a type of conveyance different from the arrangement for conveyance of the first component, wherein the arrangement for conveyance of the first downhole component is selected from the group consisting of a slickline, a wireline, a drill stem, a coiled tubing, a drill string and a tractor.

3. The system according to claim 1, wherein the second downhole component is connected to a wireless receiver adapted to receive at least one wireless transmission from the wireless transmitter.

4. The system according to claim 1, wherein the first downhole component is positioned within a first wellbore and the second downhole component is positioned in a second wellbore.

5. The system according to clam 1, wherein the second downhole component is connected to one of the formation, cement located within the borehole, and casing located within the borehole.

6. The system according to claim 4, wherein the second wellbore is a secondary wellbore to the first wellbore.

7. The system according to claim 1, wherein the second downhole component has logic for performing the task and upon receiving the electrical power from the wireless transmitter executed the logic to perform the task.

8. The system according to claim 1, wherein the second downhole component receives instructions for performing the task from the wireless transmitter.

9. The system according to claim 1, wherein the power source is one of integrated with the first downhole component and the first downhole component is a conductor connected to and in communication with a station that is located remotely with respect to the first downhole component, wherein the station is located at an intermediate position within one of the borehole and at the Earth's surface.

10. A method for providing wireless power and actuation of a downhole component located within at least one borehole formed in a formation, the method comprising:
providing a wireless transmitter within a first borehole;
wirelessly transmitting electrical power from a wireless transmitter electrically connected to a first downhole component within the first borehole; and
actuating a second downhole component via the wireless transmission such that the second component performs a task within a second borehole.

11. The method according to claim 10, further comprising:
charging a battery connected to the second downhole component, with wireless power received from the wireless transmitter.

12. The method according to claim 10, wherein the task is controlling fluid flow within the second borehole.

13. The method according to claim 10, wherein the task performed by the second downhole component is selected from a group consisting of heating a portion of one of the first borehole and a portion of a second borehole, one of restricting and halting fluid flow within one of the first borehole and within a second borehole, moving a shunt, a expandable screen and a slidable screen from a first position to a second position within the first borehole, one of expanding and contracting a packer within the borehole, releasing one of an inhibitor and a solvent into the first borehole, and mechanically agitating fluid within the first borehole.

14. A method for providing wireless power and actuation of a downhole component located within at least one borehole formed in a formation, the method comprising:
deploying a first downhole component within a first borehole, the first downhole component connected to an electrical power supply;
deploying a second downhole component at a position electrically isolated from the first component; and
wirelessly transmitting electrical power from the first downhole component to the second downhole component to actuate the second component such that the second component performs a task.

15. The method according to claim 14, further comprising:
positioning the first component within the first borehole via an arrangement for conveyance of the first component, wherein the second downhole component is deployed into the first borehole by a type of conveyance different from the arrangement for conveyance of the first component, wherein the arrangement for conveyance is selected from the group consisting of a slickline, a wireline, a drill stem, a coiled tubing, a drill string and a tractor.

16. The method according to claim 14, wherein the second component is one of connected to the formation, cement located within the borehole, and casing located within the first borehole.

17. The method according to claim 14, wherein the second downhole component is located within a second borehole.

18. The method according to claim 14, further comprising:
charging a battery connected to the second downhole component, with wireless power received from the first downhole component.

19. The method according to claim 14, wherein the task performed by the second downhole component controls fluid flow within one of the first borehole and within the second borehole.

20. The method according to claim 14, wherein the task performed by the second component is selected from a group consisting of heating a portion of the first borehole or a portion of a second borehole, restricting or halting fluid flow within the first borehole or within a second borehole, moving a shunt, a expandable screen or a slidable screen from a first position to a second position within the first borehole, expanding or contracting a packer within the borehole, releasing an inhibitor or a solvent into the first borehole, and mechanically agitating fluid within the first borehole.

21. The system according to claim 1, where the second downhole component transmits information about at least one of a current state of the downhole component and a historical state of the downhole component to the first downhole component.
